(19) United States
(12) Patent Application Publication
(10) Pub. No.: US 2022/0171439 A1
(43) Pub. Date: Jun. 2, 2022

(54) PORTABLE ELECTRONIC DEVICE

(71) Applicant: Acer Incorporated, New Taipei City (TW)

(72) Inventors: Yu-Wen Lin, New Taipei City (TW); Huei-Ting Chuang, New Taipei City (TW); Yen-Chieh Chiu, New Taipei City (TW); Po-Yi Lee, New Taipei City (TW); Hung-Chi Chen, New Taipei City (TW); Chao-Di Shen, New Taipei City (TW)

(73) Assignee: Acer Incorporated, New Taipei City (TW)

(21) Appl. No.: 17/489,697

(22) Filed: Sep. 29, 2021

(30) Foreign Application Priority Data
Dec. 2, 2020 (TW) 109142320

(51) Int. Cl. G06F 1/16; G06F 1/20

(52) U.S. Cl. CPC G06F 1/1681; G06F 1/203

(57) ABSTRACT

A portable electronic device including a first body, a second body, a hinge mechanism, a driving mechanism and a door is provided. The first body has a bottom and a heat dissipating opening located at the bottom. The second body is connected to the first body through the hinge mechanism. The driving mechanism is connected to the hinge mechanism. The door is disposed corresponding to the heat dissipating opening and is pivoted to the bottom of the first body. The door is connected to the driving mechanism and closes the heat dissipating opening in a mode. In another mode, the driving mechanism drives the door to rotate with respect to the first body, open the heat dissipating opening, and lift the first body.

### CROSS-REFERENCE TO RELATED APPLICATION

This application claims the priority benefit of Taiwanese application no. 109142320, filed on Dec. 2, 2020. The entirety of the above-mentioned patent application is hereby incorporated by reference herein and made a part of this specification.

### BACKGROUND

### Technical Field

The disclosure relates to an electronic device; particularly, the disclosure relates to a portable electronic device.

### Description of Related Art

As computing performance of notebook computers continuously increases, heat generated during operation of internal electronic elements (e.g., central processing units, graphics processing units, or other electronic elements) also continuously increases. If the heat cannot be emitted to the outside quickly, the performance of the notebook computers is likely to decline due to overheating. On the other hand, in common notebook computers, the hosts in charge of logical operation and data access are mostly placed on a work surface (e.g., a desktop), and bottoms of the hosts abut the work surface (e.g., the desktop), not only adversely affecting heat dissipation, but possibly causing discomfort during operation by users.

### SUMMARY

The disclosure provides a portable electronic device, which has increased heat dissipation efficiency and comfort during operation.

An embodiment of the disclosure proposes a portable electronic device, which includes a first body, a second body, a hinge mechanism, a driving mechanism, and a door. The first body has a bottom and a heat dissipating opening located at the bottom. The second body is connected to the first body through the hinge mechanism. The driving mechanism is connected to the hinge mechanism. The door is disposed corresponding to the heat dissipating opening and pivoted to the bottom of the first body. The door is connected to the driving mechanism. In a mode, the door closes the heat dissipating opening. In another mode, the driving mechanism drives the door to rotate with respect to the first body, open the heat dissipating opening, and lift the first body.

Based on the foregoing, in the portable electronic device of the disclosure, the heat dissipation mechanism and the lifting mechanism are integrated, increasing the convenience in the operation by the user. Based on the opening of the heat dissipation mechanism, the heat generated by the internal heat source of the first body can be quickly emitted to the outside through the heat dissipating opening. Based on the opening of the lifting mechanism, the first body is lifted with respect to the work surface (e.g., the desktop) and the angle of the first body can be adjusted, increasing the comfort of the user when operating the first body.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a partially enlarged schematic side view of a portable electronic device in a closed state according to an embodiment of the disclosure.

FIG. 2 is a partially enlarged schematic view of a hinge mechanism, a driving mechanism, and a door of FIG. 1 from another view angle.

FIG. 3 is a partially enlarged side view of the portable electronic device of FIG. 1 in an unfolded state.

### DESCRIPTION OF THE EMBODIMENTS

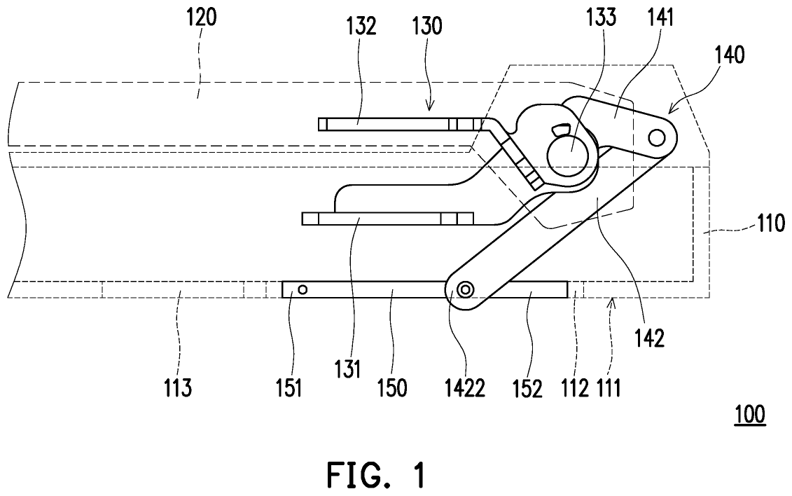

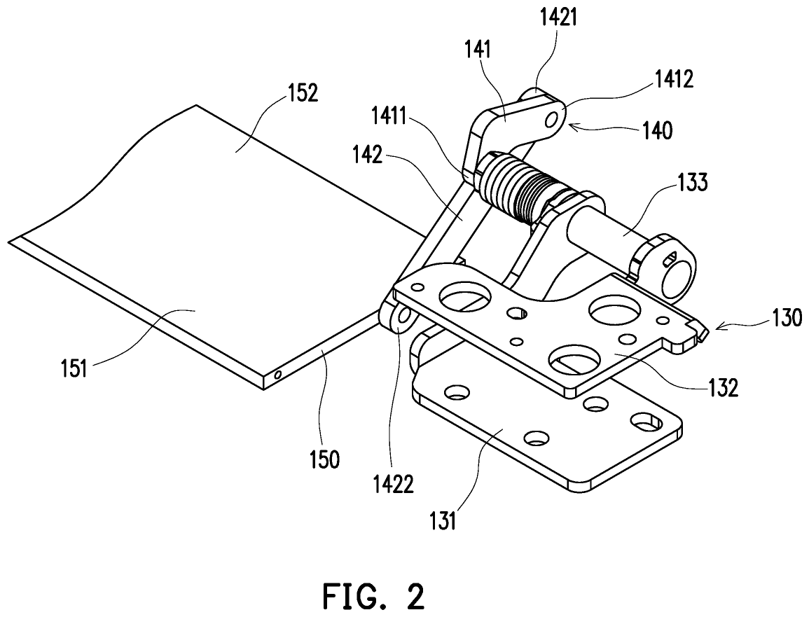

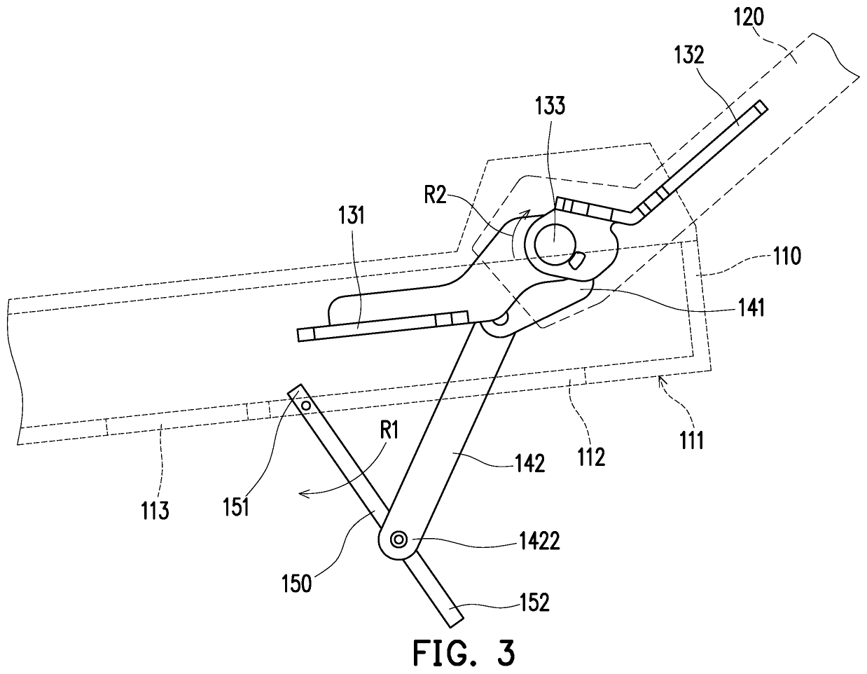

FIG. 1 is a partially enlarged schematic side view of a portable electronic device in a closed state according to an embodiment of the disclosure. FIG. 2 is a partially enlarged schematic view of a hinge mechanism, a driving mechanism, and a door of FIG. 1 from another view angle. FIG. 3 is a partially enlarged side view of the portable electronic device of FIG. 1 in an unfolded state. Notably, first body 110 and second body 120 are drawn with dashed lines in order to clearly show the configuration of the internal structure.

With reference to FIG. 1 to FIG. 3, in this embodiment, a portable electronic device 100 may be a notebook computer, which includes a first body 110, a second body 120, a hinge mechanism 130, a driving mechanism 140, and a door 150. The first body 110 is a host capable of logical operation and data access, and the second body 120 is a display. On the other hand, the second body 120 is connected to the first body 110 through the hinge mechanism 130 to rotate with respect to the first body 110 and switch between the closed state as shown in FIG. 1 and the unfolded state as shown in FIG. 3.

As shown in FIG. 3, during operation of the first body 110, heat is generated by an internal heat source (e.g., a central processing unit, a graphics processing unit, or other electronic elements) thereof, and the heat generated by the internal heat source requires to be quickly emitted to the outside to prevent the performance of the first body 110 from declining.

As shown in FIG. 1, the first body 110 has a heat dissipating opening 112 located at a bottom 111, and the heat dissipating opening 112 is closed by the door 150 to prevent dust or other foreign objects from the outside from entering an inside of the first body 110 through the heat dissipating opening 112. As shown in FIG. 3, the door 150 rotates with respect to the first body 110 and opens the heat dissipating opening 112. During operation of the first body 110, the heat generated by the internal heat source thereof can be quickly emitted to the outside through the heat dissipating opening 112 to maintain the performance of the first body 110. When the heat dissipating opening 112 is opening, the door 150 supports the first body 110, so that the bottom 111 of the first body 110 is lifted with respect to a work surface (e.g., a desktop) to increase the space for dissipating hot air. Besides, the first body 110 is supported by the door 150 and is inclined with respect to the work surface (e.g., the desktop), so that an operating angle of the first body 110 is adjusted, thereby increasing the comfort of a user when operating the first body 110.

That is to say, in the portable electronic device 100, a heat dissipation mechanism and a lifting mechanism are integrated, so that the opening and the closing of the heat dissipation mechanism and the lifting mechanism are substantially synchronous, increasing convenience in the operation by the user.

With reference to FIG. 1 and FIG. 3, the first body 110 also has an air intaking opening 113 located at the bottom 111. The air intaking opening 113 is configured for cold air from the outside to flow into the inside of the first body 110, and the heat dissipating opening 112 is configured for emitting hot air in the inside of the first body 110 to the outside. The heat dissipating opening 112 is adjacent to the air intaking opening 113. When the heat dissipating opening 112 is open, the door 150 blocks the airflow path between the heat dissipating opening 112 and the air intaking opening 113, preventing the hot air from returning into the inside of the first body 110 through the air intaking opening 113.

With reference to FIG. 1 to FIG. 3, during a rotation of the second body 120 with respect to the first body 110, the hinge mechanism 130 drives the driving mechanism 140, and the driving mechanism 140 drives the door 150 to rotate with respect to the first body 110. That is to say, the rotation of the door 150 with respect to the first body 110 is synchronous with the rotation of the second body 120 with respect to the first body 110. Furthermore, as an expansion angle of the second body 120 with respect to the first body 110 gradually increases to a predetermined angle, an expansion angle of the door 150 with respect to the first body 110 also gradually increases, and at the same time, an inclination angle of the first body 110 with respect to the work surface (e.g., the desktop) also gradually increases.

The predetermined angle may be 120 degrees, but the disclosure is not limited thereto. If the expansion angle of the second body 120 with respect to the first body 110 exceeds 120 degrees and gradually increases, the expansion angle of the door 150 with respect to the first body 110 gradually decreases, and at the same time, the inclination angle of the first body 110 with respect to the work surface (e.g., the desktop) gradually decreases.

In this embodiment, the driving mechanism 140 is connected to the hinge mechanism 130, and the door 150 is connected to the driving mechanism 140. The door 150 is disposed corresponding to the heat dissipating opening 112, and is pivoted to the bottom 111 of the first body 110. To be specific, the hinge mechanism 130 has a first bracket 131, a second bracket 132, and a shaft 133. The first bracket 131 is fixed to the first body 110, and the second bracket 132 is fixed to the second body 120. The shaft 133 is fixed to the second bracket 132, and the shaft 133 is rotatably disposed through the first bracket 131. The driving mechanism 140 is connected to the shaft 133.

When the second body 120 rotates with respect to the first body 110, the second bracket 132 and the shaft 133 move synchronously with the second body 120 and rotate with respect to the first bracket 131. At the same time, the driving mechanism 140 is driven by the shaft 133 to drive the door 150 to rotate with respect to the first body 110. In addition, a rotation direction R1 of the door 150 is the same as a rotation direction R2 of the shaft 133.

With reference to FIG. 1 to FIG. 3, the driving mechanism 140 includes a first driving rod 141 and a second driving rod 142. The first driving rod 141 is connected to the shaft 133 and moves synchronously with the shaft 133. The second driving rod 142 is pivoted to the first driving rod 141, and the door 150 is pivoted to the second driving rod 142. When the first driving rod 141 rotates synchronously with the shaft 133, the second driving rod 142 and the first driving rod 141 rotate with respect to each other, and the second driving rod 142 pushes the door 150 to rotate with respect to the first body 110 or pulls the door 150 to rotate with respect to the first body 110.

Furthermore, the first driving rod 141 has a fixing end 1411 and a first pivoting end 1412 opposite to the fixing end 1411. The fixing end 1411 is fixed to the shaft 133, and the first pivoting end 1412 is pivoted to the second driving rod 142. The second driving rod 142 has a second pivoting end 1421 and a third pivoting end 1422 opposite to the second pivoting end 1421. The second pivoting end 1421 is pivoted to the first pivoting end 1412, and the third pivoting end 1422 is pivoted to the door 150.

On the other hand, the door 150 has a fourth pivoting end 151 and a movable end 152. The fourth pivoting end 151 is pivoted to the bottom 111 of the first body 110, and the third pivoting end 1422 is located between the fourth pivoting end 151 and the movable end 152. When the door 150 is expanding with respect to the first body 110, the movable end 152 moves away from the bottom 111, or the heat dissipating opening 112, of the first body 110 and opens the heat dissipating opening 112. At the same time, the movable end 152 of the door 150 abuts the work surface (e.g., the desktop) to support the first body 110. On the contrary, the movable end 152 of the door 150 moves close to the bottom 111, or the heat dissipating opening 112, of the first body 110 and closes the heat dissipating opening 112.

Notably, the fourth pivoting end 151 is located between the heat dissipating opening 112 and the air intaking opening 113. That is to say, the heat dissipating opening 112 and the air intaking opening 113 are located on two opposite sides of the fourth pivoting end 151.

In summary of the foregoing, in the portable electronic device of the disclosure, the heat dissipation mechanism and the lifting mechanism are integrated, so that the opening and the closing of the heat dissipation mechanism and the lifting mechanism are substantially synchronous, increasing the convenience in the operation by the user. Based on the opening of the heat dissipation mechanism, the door rotates with respect to the first body and opens the heat dissipating opening, so that the heat generated by the internal heat source of the first body can be quickly emitted to the outside through the heat dissipating opening. Based on the opening of the lifting mechanism, the door supports the first body, so that the bottom of the first body is lifted with respect to the work surface (e.g., the desktop) to increase the space for dissipating hot air. Besides, the first body is supported by the door and is inclined with respect to the work surface (e.g., the desktop), so that the operating angle of the first body is adjusted, increasing the comfort of the user when operating the first body.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A portable electronic device, comprising:
a first body having a bottom and a heat dissipating opening located at the bottom;
a second body;
a hinge mechanism, wherein the second body is connected to the first body through the hinge mechanism;
a driving mechanism connected to the hinge mechanism; and
a door disposed corresponding to the heat dissipating opening, pivoted to the bottom of the first body, and connected to the driving mechanism, wherein in a mode, the door closes the heat dissipating opening, and in another mode, the driving mechanism drives the door to rotate with respect to the first body, open the heat dissipating opening, and lift the first body.

2. The portable electronic device according to claim 1, wherein the first body further has an air intaking opening located at the bottom, and the air intaking opening is adjacent to the heat dissipating opening.

3. The portable electronic device according to claim 2, wherein the door blocks between the heat dissipating opening and the air intaking opening.

4. The portable electronic device according to claim 1, wherein the hinge mechanism comprises a first bracket, a second bracket, and a shaft, the first bracket is fixed to the first body, the second bracket is fixed to the second body, and the shaft is connected to the second bracket, wherein the shaft is rotatably disposed through the first bracket, and the driving mechanism is connected to the shaft.

5. The portable electronic device according to claim 4, wherein the driving mechanism comprises a first driving rod and a second driving rod, the first driving rod is fixed to the shaft, the second driving rod is pivoted to the first driving rod, and the door is pivoted to the second driving rod.

6. The portable electronic device according to claim 5, wherein the first driving rod has a fixing end and a first pivoting end opposite to the fixing end, the fixing end is fixed to the shaft, and the first pivoting end is pivoted to the second driving rod.

7. The portable electronic device according to claim 6, wherein the second driving rod has a second pivoting end and a third pivoting end opposite to the second pivoting end, the second pivoting end is pivoted to the first pivoting end, and the third pivoting end is pivoted to the door.

8. The portable electronic device according to claim 7, wherein the door has a fourth pivoting end and a movable end opposite to the fourth pivoting end, the fourth pivoting end is pivoted to the bottom of the first body, and the third pivoting end is located between the fourth pivoting end and the movable end.

9. The portable electronic device according to claim 8, wherein the movable end of the door moves away from or moves close to the heat dissipating opening.

10. The portable electronic device according to claim 5, wherein the first driving rod rotates synchronously with the shaft, the second driving rod and the first driving rod rotate with respect to each other, the second driving rod pushes or pulls the door to rotate with respect to the first body, and a rotation direction of the door is the same as a rotation direction of the shaft.
